(19) United States
(12) Patent Application Publication
(10) Pub. No.: US 2013/0111813 A1
(43) Pub. Date: May 9, 2013

(54) PREVENTING THE IMPROPER INSTALLATION OF AN AUTOMATIC DOOR SAFETY CIRCUIT

(71) Applicant: Joseph Rozgonyi, Aventura, FL (US)

(72) Inventor: Joseph Rozgonyi, Aventura, FL (US)

(21) Appl. No.: 13/289,035

(22) Filed: Nov. 4, 2011

(51) Int. Cl. E05F 15/20

(52) U.S. Cl. 49/27; 49/506

(57) ABSTRACT

A system to prevent the improper installation of a safety circuit used to keep an automatic door from closing on an obstruction includes an automatic door operator for opening and closing the automatic door. A sensor system is provided for allowing the automatic door operator to close the automatic door whenever no obstruction is under the automatic door. The sensor system further prevents the automatic door operator from closing the automatic door whenever an obstruction is under the automatic door. Further, the sensor system prevents the automatic door operator from closing the automatic door when the sensor system is improperly installed such that an obstruction under the automatic door is undetectable.

### TECHNICAL FIELD OF THE INVENTION

The present invention relates generally to an improved infrared photocell sensor system to ensure the safety of opening and closing a movable barrier. More specifically, the present invention relates to an infrared photocell sensor system to ensure the safety of opening and closing a movable barrier which precludes the possibility of unsafe installation of the photo sensor system so that the movable barrier only operates when installed correctly and within the prescribed safety guidelines.

### BACKGROUND OF THE INVENTION

Movable barrier operators are well known in the art. Such operators generally serve to selectively move a movable barrier (such as a segmented or one-piece garage door, swinging gate, sliding gate, rolling shutter, and so forth) between an opened and a closed position using one or more motors. It is also known to use safe-operation sensors with such operators to aid in ensuring that the movable barrier can be so moved without undue risk to persons or property in the immediate vicinity. Typically, such sensors are designed to detect an obstacle in the path of the moving barrier (particularly when the moving barrier moves to a closed position) through use of light, sound (including ultrasonic sound), radio-frequency, and/or contact sensing mechanisms. Upon sensing an obstacle, the sensor provides a corresponding signal, which signal can be used by the movable barrier operator accordingly to aid in avoiding potentially harmful contact between the movable barrier and the detected obstacle.

### SUMMARY OF THE INVENTION

According to an embodiment of the present invention, a system to prevent the improper installation of a safety circuit used to keep an automatic door from closing on an obstruction includes an automatic door operator for opening and closing the automatic door. A sensor system is provided for allowing the automatic door operator to close the automatic door whenever no obstruction is under the automatic door. The sensor system further prevents the automatic door operator from closing the automatic door whenever an obstruction is under the automatic door. Further, the sensor system prevents the automatic door operator from closing the automatic door when the sensor system is improperly installed such that an obstruction under the automatic door is undetectable.

According to another embodiment of the present invention, a method of preventing the improper installation of a safety circuit used to keep an automatic door from closing on an obstruction includes opening and closing the automatic door with an automatic door operator. The automatic door operator is allowed to close the automatic door whenever no obstruction is under the automatic door. The automatic door operator also prevents the automatic door from closing whenever an obstruction is under the automatic door or when the safety circuit is improperly installed such that an obstruction under the automatic door is undetectable.

Also according to an embodiment of the present invention, a system is provided that prevents the improper installation of a safety circuit used to keep an automatic door from closing on an obstruction. The system includes an automatic door operator for opening and closing the automatic door and a sensor system for allowing the automatic door operator to close the automatic door whenever no obstruction is under the automatic door. The sensor system also prevents the automatic door operator from closing the automatic door whenever an obstruction is under the automatic door. Further, the sensor system prevents the automatic door operator from closing the automatic door when the sensor system is improperly installed such that an obstruction under the automatic door is undetectable. The sensor system includes a discrimination module for outputting first, second and third discriminator output signals to the automatic door operator corresponding to no obstruction under the automatic door, an obstruction under the automatic door, and the sensor system being improperly installed, respectively.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a three-dimensional front view of an overhead door assembly with properly installed entrapment protection, in accordance with the present invention.

FIG. 2 is a three-dimensional front view of an overhead door assembly with improperly installed entrapment protection, in accordance with the present invention.

FIG. 3 is a representation of a properly installed safety circuit employed with the typical overhead door assembly, in accordance with the present invention.

FIG. 4 is a representation of the properly installed safety circuit employed with the typical overhead door assembly when an obstruction is present, in accordance with the present invention.

FIG. 5 is a representation of an improperly installed the safety circuit employed with the typical overhead door assembly, in accordance with the present invention.

FIG. 6 is a representation of an improved safety circuit employed with a typical overhead door assembly to prevent operation of the overhead door when the safety circuit is improperly installed, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

The present invention is directed to an improved infrared photocell sensor (hereafter “improved sensor”) system 30, as shown in FIG. 6. The infrared photocell sensor system 30 is used in conjunction with automatic gate, door and barrier operators (not shown) to protect people from entrapment the gate, door or barrier which are actuated by automatic operators to close by timers, or to prevent damage to people or property during the closing of the gate, door or barrier (called automatic overhead door herein). The same infrared photocell sensor system is also used for protection of people and other objects during the opening cycle of the garage door with the automatic operators. For example, if a person or object is in the path between infrared photocell sensors, the automatic operators are prevented from opening the garage door. This secondary entrapment protection is mandated by protection agencies and monitored for presence by automatic operator electronic circuitry. However, there are situations when the photocell sensor system is improperly installed, leading to dangerous situations when an obstruction or entrapment situation is present. The improved sensor system 30 is designed to prevent the undesired operation of the garage door with the operators.

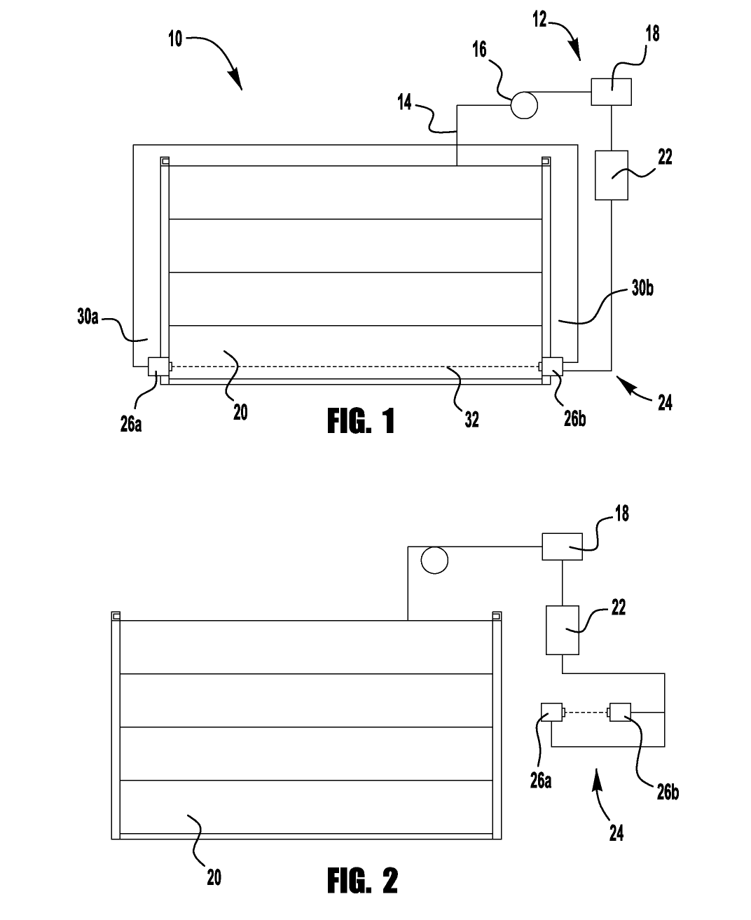

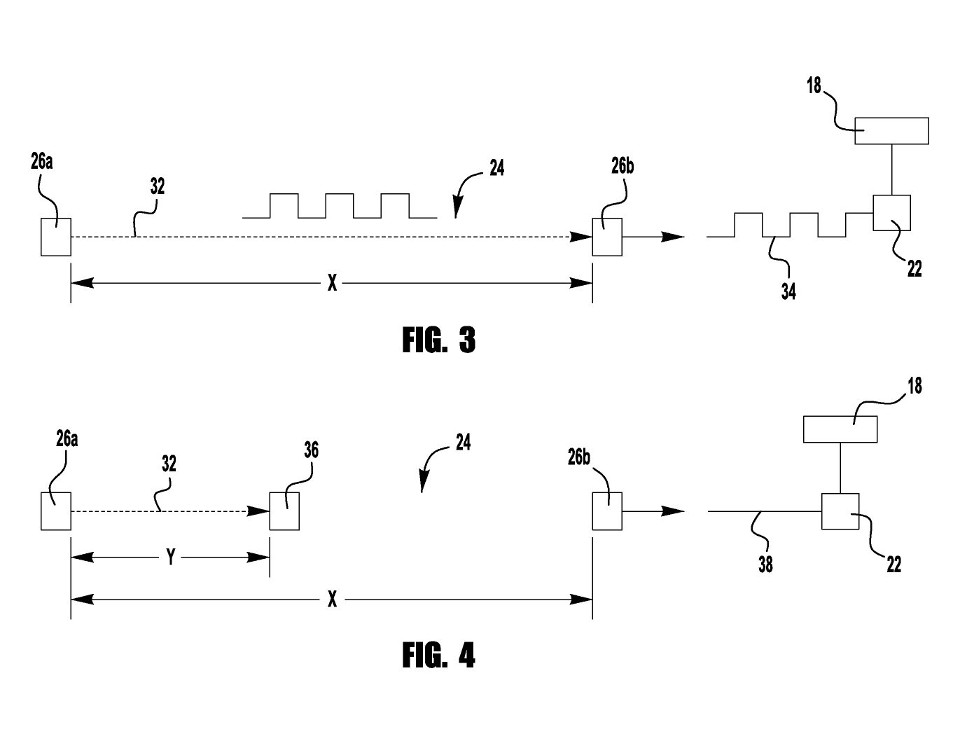

As seen in FIG. 1, a typical overhead garage door assembly 10 is illustrated with an automatic door operator 12, such as a chain 14 and sprocket 16, driven by a motor 18 to move an overhead door 20 between an opened and a closed position in response to first and second control signals from a control operator 22. A push button device (not shown) or a portable radio frequency transmitter (not shown) are generally provided to generate the first and second control signals to the control operator. Overhead door assembly 10 employs a safety circuit 24 consisting of an infrared photocell transmitter 26a, an infrared photocell receiver 26b and the control operator 22 (as described in more detail below). On either side 30a and 30b of the door 20, the infrared photocell transmitter and receiver 12a and 12b, respectively, are installed according to specifications by the automatic door operator manufacturer, usually several inches above the ground on each side of the door. The infrared photocell transmitter and receiver 26a and 26b, respectively, are typically spaced a distance X (see FIG. 3), of between about 10 and 45 feet apart from each other. Including a safety circuit 24 with the garage door assembly 10 is important because it prevents the overhead door 20 from closing on people, pets or other obstructions and, therefore, prevents personal injury and property damage. In the event that the overhead door assembly 10 utilizes automatic operators that are actuated to close by timers, the safety circuit 24 protects people from entrapment.

In operation, when an obstruction blocks the transmission of an infrared beam 32 from the infrared photocell transmitter 26a to the infrared photocell receiver 26b, a blockage signal indicating the presence of an obstruction blocking the transmission of an infrared beam from the infrared photocell transmitter 26a to the infrared photocell receiver 26b is transmitted to the control operator 22. In response to this blockage signal, the control operator 22 sends a stop signal to the motor 18 to prevent the overhead door 20 from closing further and if desired to immediately open.

FIG. 3 illustrates a representation of the safety circuit 24 employed with the typical overhead door assembly 10. An infrared beam 32 is constantly transmitted from the infrared photocell sensor transmitter 12a to the infrared photocell sensor receiver 12b. In the absence of an obstruction, a first output signal 34, such as a square pattern wave, is transmitted from the infrared photocell receiver 26b to the control operator 22. Control operator 22 recognizes the output signal 34 to mean that there is no obstruction between the infrared photocell transmitter 26a to the infrared photocell receiver 26b. Under these conditions, the overhead door 20 operates in a normal manner of opening in response to the first and second control signals from control operator 22. The first control signal causes the overhead door 20 to open and the second control signal causes the overhead door to close.

FIG. 4 illustrates a representation of the safety circuit 24 employed with the typical overhead door assembly 10, when an obstruction is present. In this situation, an obstruction 36 lies between the infrared photocell sensor transmitter 26a and the infrared photocell sensor receiver 26b at a distance Y from the infrared photocell sensor transmitter. Obstruction 36 acts to interrupt the infrared beam 32 that the infrared photocell sensor transmitter 26a is sending, and as a result, infrared photocell sensor receiver 26b no longer senses the infrared beam. This in turn causes the infrared photocell sensor receiver 26b to output a second output signal 38, such as a constant wave, to the control operator 22. The receipt of the constant wave, in turn, causes the control operator 22 to relays a stop signal to the motor 18 whereby the overhead door 20 either does not close or immediately opens. This acts to protect the obstruction 36 from potential damage from contact with the otherwise closing overhead door 20.

However, as seen in FIG. 2, the installer may elect to improperly install the infrared photocell transmitter 26a and the infrared photocell receiver 26b in an alternative location, which is easier and more expedient than properly installing the infrared photocell transmitter and the infrared photocell receiver on either side of the overhead door 20, as shown in FIG. 1. For example, it is conceivable that the installer mounts the infrared photocell transmitter 26a and the infrared photocell receiver 26b facing and in close proximity to each other, such as on a wall adjacent to the overhead door 20. Sometimes installers improperly mount the infrared photocell transmitter 26a and the infrared photocell receiver 26b in such a manner because it is much easier and quicker than mounting them properly.

When improperly mounted, as shown in FIG. 2, the overhead door 20 can cause damage to an object or person beneath the door as it closes because the infrared photocell sensors 26a and 26b of safety circuit 24 cannot signal the control operator 22 of the potential obstruction. In this situation, the overhead door 20 will be fully operational but because of the improper installation, it will be operating without entrapment or obstruction protection, because even if there was an obstruction under door 20 or an entrapment situation, the infrared photocell sensors 26a and 26b would obviously be unable to detect it.

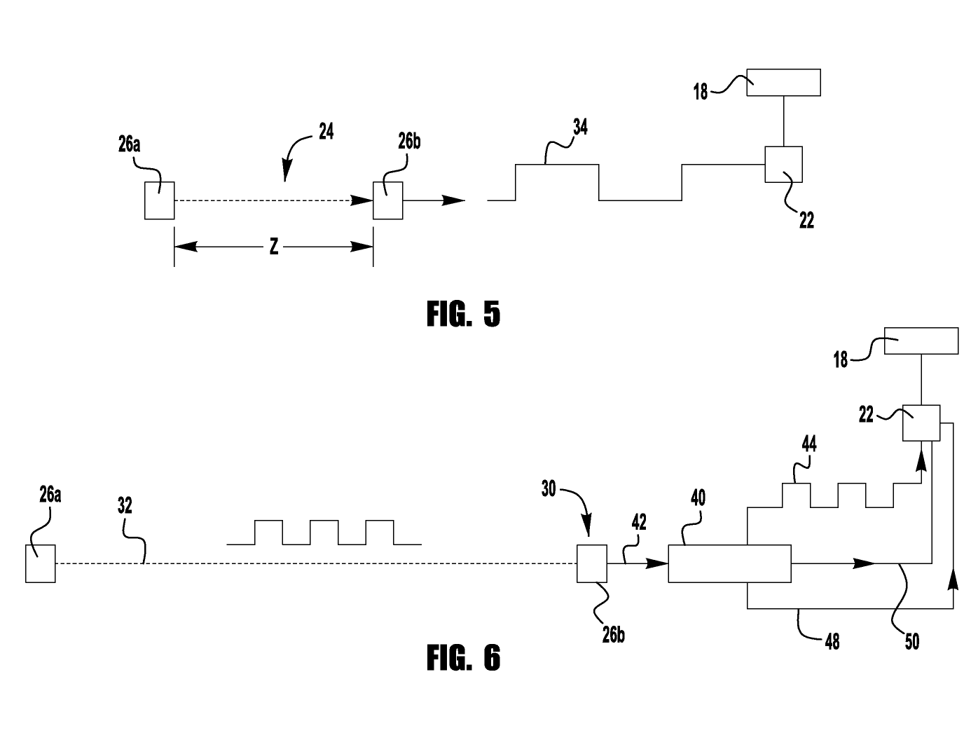

FIG. 5 illustrates a representation of the safety circuit 24 employed with the typical overhead door assembly 10 when the system is improperly installed. Infrared photocell sensor transmitter 26a and infrared photocell sensor receiver 26b are separated by a distance Z of less the distance X, e.g., of less than about 8 feet, and are mounted in a location remote from the actual door 20. Infrared beam 32 is constantly sent from the infrared photocell sensor transmitter 26a to the infrared photocell sensor receiver 26b independently of whether or not there is an obstruction under the door 20. Therefore, first output signal 34, such as a square pattern wave, from the infrared photocell sensor receiver 26b is transmitted to the control operator 22. Control operator 22 recognizes the first output signal 34 to mean that there is no obstruction, and the door 20 is allowed to operate in a normal manner, even if an obstruction is present.

To protect against the possibility of an improperly installed safety system, the current embodiment is provided with an improved safety circuit system 30. As seen in FIG. 6, the safety circuit 30 includes an infrared photocell transmitter 26a, an infrared photocell receiver 26b disposed on either side of the door 20, as shown in FIG. 1, and a control operator 22 which is adapted to send a stop signal to the motor 18 to prevent the overhead door 20 from closing further and if desired to immediately open when an obstruction is present under the door, and a discrimination module 40.

As before, infrared beam 32 is constantly sent from the infrared photocell sensor transmitter 26a to the infrared photocell sensor receiver 26b. The infrared photocell sensor receiver 26b transmits a signal output 42 to the discrimination module 40. The signal output 42 is provided whether or not the system is properly installed. The discrimination module 40 measures the signal output 34 which corresponds to the frequency and/or pulse amplitude and/or width of the received infrared beam 32.

In normal operation, as described with reference to FIG. 1, when there is no obstruction, the output signal 42 from the infrared photocell sensor receiver 12b has a first wave pattern, such as a square pattern wave, which is recognized by the discrimination module 40 to mean that there is no obstruction. In that case, the discrimination module 40 will direct a first discriminator output signal 44 to the control operator 22. Control operator 22 recognizes the first discriminator output signal 44 to mean that there is no obstruction, and the overhead door 20 is allowed to operate in a normal manner.

If there is an obstruction (not shown) between the infrared photocell sensor transmitter 26a and the infrared photocell sensor receiver 26b, the obstruction acts to interrupt the infrared beam 32 that the infrared photocell sensor transmitter 26a is sending, and as a result, infrared photocell sensor receiver 26b no longer senses the infrared beam. This in turn causes the output signal 42 from the infrared photocell sensor receiver 26b being sent to the discrimination module 40 to have a second wave pattern, such as a constant wave, which is different from the first wave pattern and which is recognized by the discrimination module 40 to mean that there is an obstruction below the door 20. In that case, the discrimination module 40 will direct a second discriminator output signal 48, such as a constant wave, to the control operator 22. Control operator 22 recognizes the second discriminator output signal 48 to mean that there is an obstruction, and this is turn causes the control operator 22 to relay a stop signal to the motor 18 whereby the overhead door either does not close or immediately opens. If the output signal 42 from the infrared photocell sensor receiver 26b has a third wave pattern, such as a square pattern wave, which is different from the both the first and second wave patterns and which exceeds a predetermined threshold value because the distance between infrared photocell sensor transmitter 26a and infrared photocell sensor receiver 26b is a distance Z of less than about 8 feet, the discrimination module 40 will send a third discriminator output signal 50, such as a constant wave, which the control operator 22 recognizes to mean that the infrared photocell sensor transmitter 26a and the infrared photocell sensor receiver 26b are not properly installed. This will in turn cause the control operator 22 to relay a stop signal to the motor 18 whereby the overhead door either does not close or immediately opens.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A system to prevent the improper installation of a safety circuit used to keep an automatic door from closing on an obstruction, comprising:
an automatic door operator for opening and closing the automatic door;
a sensor system for allowing the automatic door operator to close the automatic door whenever no obstruction is under the automatic door;
said sensor system preventing the automatic door operator from closing the automatic door whenever an obstruction is under the automatic door;
said sensor system preventing the automatic door operator from closing the automatic door when the sensor system is improperly installed such that an obstruction under the automatic door is undetectable.

2. The system of claim 1, wherein the sensor system includes a discrimination module for outputting:
a) a first discriminator output signal to the automatic door operator whenever no obstruction is under the automatic door;
b) a second discriminator output signal to the automatic door operator whenever an obstruction is under the automatic door; and
c) a third discriminator output signal to the automatic door operator when the sensor system is improperly installed.

3. The system of claim 2, wherein the sensor system further comprises:
an infrared photocell sensor transmitter for directing an infrared beam towards an infrared photocell sensor receiver;
said infrared photocell sensor receiver outputs an output signal to the discrimination module corresponding to the wave pattern of the infrared beam whereby the discrimination module outputs the first, second and third discriminator output signals to the automatic door operator.

4. The system of claim 1 wherein the automatic door operator for opening and closing the automatic door includes a chain and crank driven by a motor.

5. The system of claim 3 wherein the photocell sensor transmitter is on one side of the automatic door and the infrared photocell sensor receiver is placed opposite photocell sensor transmitter on the other side of the automatic door.

6. The system of claim 5 wherein the distance between the photocell sensor transmitter and the infrared photocell sensor receiver is between about 8 and 45 feet.

7. The system of claim 3 wherein the distance between the photocell sensor transmitter and the infrared photocell sensor receiver is less than about 8 feet when the sensor system is improperly installed.

8. The system of claim 2 wherein the first discriminator output signal has a first wave pattern, the second discriminator output signal has a second wave pattern that is different from the first wave pattern, and the third discriminator output signal has a third wave pattern that is different from both the first wave pattern and the second wave pattern.

9. A method of preventing the improper installation of a safety circuit used to keep an automatic door from closing on an obstruction, comprising:
opening and closing the automatic door with an automatic door operator;
allowing the automatic door operator to close the automatic door whenever no obstruction is under the automatic door;
preventing the automatic door operator from closing the automatic door whenever an obstruction is under the automatic door; and
preventing the automatic door operator from closing the automatic door when the safety circuit is improperly installed such that an obstruction under the automatic door is undetectable.

10. The method of claim 9, further comprising:
a) outputting a first discriminator output signal to the automatic door operator whenever no obstruction is under the automatic door;
b) outputting a second discriminator output signal to the automatic door operator whenever an obstruction is under the automatic door; and
c) outputting a third discriminator output signal to the automatic door operator when the safety circuit is improperly installed.

11. The method of claim 10, further comprising:
directing an infrared beam towards an infrared photocell sensor receiver;
outputting an output signal from the infrared photocell sensor receiver to a discrimination module corresponding to the wave pattern of the infrared beam; and
outputting the first, second and third discriminator output signals to the automatic door operator from the discrimination module.

12. The method of claim 9 including opening and closing the automatic door with an automatic door operator including a chain and crank driven by a motor.

13. The method of claim 11 including mounting the photocell sensor transmitter on one side of the automatic door and mounting the infrared photocell sensor receiver opposite thereto on the other side of the automatic door.

14. The method of claim 13 including disposing the photocell sensor transmitter and the infrared photocell sensor receiver at a distance between about 8 and 45 feet.

15. The method of claim 11 wherein improperly installing the photocell sensor transmitter and the infrared photocell sensor receiver occurs when the photocell sensor transmitter and the infrared photocell sensor receiver are disposed from each other a distance of less than about 8 feet.

16. The method of claim 10 including outputting the first discriminator output signal with a first wave pattern, the second discriminator output signal with a second wave pattern that is different from the first wave pattern, and the third discriminator output signal with a third wave pattern that is different from both the first wave pattern and the second wave pattern.

17. A system to prevent the improper installation of a safety circuit used to keep an automatic door from closing on an obstruction, comprising:
an automatic door operator for opening and closing the automatic door;
a sensor system for allowing the automatic door operator to close the automatic door whenever no obstruction is under the automatic door;
said sensor system preventing the automatic door operator from closing the automatic door whenever an obstruction is under the automatic door;
said sensor system preventing the automatic door operator from closing the automatic door when the sensor system is improperly installed such that an obstruction under the automatic door is undetectable, said sensor system includes a discrimination module for outputting first, second and third discriminator output signals to the automatic door operator corresponding to no obstruction under the automatic door, an obstruction under the automatic door, and the sensor system being improperly installed, respectively.

18. The system of claim 17, wherein the sensor system further comprises:
an infrared photocell sensor transmitter for directing an infrared beam towards an infrared photocell sensor receiver;
said infrared photocell sensor receiver outputs an output signal to the discrimination module corresponding to the wave pattern of the infrared beam whereby the discrimination module outputs the first, second and third discriminator output signals to the automatic door operator.

19. The system of claim 18 wherein the photocell sensor transmitter is on one side of the automatic door and the infrared photocell sensor receiver is opposite the photocell sensor transmitter on the other side of the automatic door.

20. The system of claim 19 wherein the distance between the photocell sensor transmitter and the infrared photocell sensor receiver is less than about 8 feet when the sensor system is improperly installed.
